(19) United States
(12) Patent Application Publication
(10) Pub. No.: US 2010/0254232 A1
(43) Pub. Date: Oct. 7, 2010

(54) LENS UNIT, OPTICAL SYSTEM, RECORDING/PLAYBACK APPARATUS AND METHOD FOR RECORDING TO AND/OR REPRODUCING FROM A RECORDING MEDIUM

(76) Inventors: Yun Sup Shin, Seoul (KR); Jeong Kyo Seo, Seoul (KR)

Correspondence Address: BIRCH STEWART KOLASCH & BIRCH, PO BOX 747, FALLS CHURCH, VA, 22040-0747, US

(21) Appl. No.: 12/679,225

(22) PCT Filed: Sep. 17, 2008
(86) PCT No.: PCT/KR2008/005471

§ 371 Date: Mar. 19, 2010

(30) Foreign Application Priority Data
Sep. 21, 2007 (KR) 10-2007-0096495

(51) Int. Cl. G11B 7/00; G02F 1/1335

(52) U.S. Cl. 369/44.14; 349/57; G9B/7

(57) ABSTRACT

A lens unit, an optical system, a recording/playback apparatus and a method for recording to and/or reproducing from a recording medium to compensate for a spherical aberration and perform stable recording or reproduction of data in recording or reproducing data to or from a recording medium having a plurality of recording layers are disclosed. The lens unit includes a first lens for condensing light beams outputted from a light source to a recording medium, a second lens for increasing a numerical aperture of the first lens to form a near field, and a liquid crystal device for compensating for a spherical aberration included in the first lens and the second lens, thereby compensating for the spherical aberration.

### TECHNICAL FIELD

The present invention relates to a lens unit, an optical system, a recording/playback apparatus and a method for recording to and/or reproducing from a recording medium, and more particularly, to compensation for a spherical aberration and stable recording or reproduction of data in recording or reproducing data to or from a recording medium having a plurality of recording layers.

### BACKGROUND ART

A recording/playback apparatus using light records or reproduces data to or from various disc-shaped recording media. In recent years, high-quality motion image processing has been required with the advancement of consumers likings to a high class. Also, the increase in density of the recording media has been required with the development of a motion picture compression technology. To this end, there have been recently developed a blue-ray disc using a blue light of a short wavelength, a HD-DVD, and a near field recording (NFR) apparatus based on near field optics as a technology related to high-density recording media. At the same time, there have been developed recording media having a plurality of recording layers.

A lens unit is set based on a first recording layer with respect to the multilayered recording media. As a result, a spherical aberration occurs when a lens is adjusted to record or reproduce data to or from a second recording layer or another recording layer. Consequently, measures to remove the spherical aberration are being required. In particular, when a near field is used, the measures to adjust the distance between the lens unit and the corresponding recording medium are also being required.

### DISCLOSURE OF INVENTION

### Technical Problem

An object of the present invention devised to solve the problem lies on compensation for a spherical aberration during the movement of a recording layer.

Another object of the present invention devised to solve the problem lies on the provision of a lens unit usable for a multilayered recording medium and an apparatus using the same.

Another object of the present invention devised to solve the problem lies on the provision of a lens unit usable for a multilayered recording medium in an apparatus using a near field and an apparatus using the same.

A further object of the present invention devised to solve the problem lies on the provision of a focus control method and a method for recording to and/or reproducing from a recording medium using the same.

### Technical Solution

The object of the present invention can be achieved by providing a lens unit including a first lens for condensing light beams outputted from a light source to a recording medium, a second lens for increasing a numerical aperture of the first lens to form a near field, and a liquid crystal device for compensating for a spherical aberration included in the first lens and the second lens.

Preferably, the liquid crystal device is disposed between the first lens and the second lens, and particles constituting the liquid crystal device exhibit an orientation changeable according to voltage applied to the liquid crystal device. The liquid crystal device may be configured to exhibit different refractive indexes with respect to light beams incident on the liquid crystal device at different incident angles.

In another aspect of the present invention, provided herein is an optical system including a first lens for condensing light beams outputted from a light source to a recording medium, a second lens for increasing a numerical aperture of the first lens to form a near field, a liquid crystal device for compensating for a spherical aberration included in the first lens and the second lens, a focus adjustment unit for changing incident angles of the light beams incident on the first lens, a beam splitter for separating or synthesizing paths of the light beams, and a light receiving unit for receiving light beams reflected from the recording medium and condensed through a lens unit constituted by the first lens, the second lens, and the liquid crystal device to generate an electric signal.

Preferably, the beam splitter includes a non-polarized device for transmitting some of the light beams and reflecting some of the light beams and a polarized device for transmitting the light beams polarized in a predetermined direction according to a polarizing direction. Also, the light receiving unit includes an RF light receiving unit for receiving the reflected light beams separated by the polarized device and a GE light receiving unit for receiving the reflected light beams separated by the non-polarized device.

In another aspect of the present invention, provided herein is a recording/playback apparatus including a first lens for condensing light beams outputted from a light source to a recording medium, a second lens for increasing a numerical aperture of the first lens to form a near field, a liquid crystal device for compensating for a spherical aberration included in the first lens and the second lens, a focus adjustment unit for changing incident angles of the light beams incident on the first lens, a beam splitter for separating or synthesizing paths of the light beams, a light receiving unit for receiving light beams reflected from the recording medium and condensed through a lens unit constituted by the first lens, the second lens, and the liquid crystal device to generate an electric signal, and a control unit for outputting a control signal corresponding to the electric signal of the light receiving unit.

Preferably, the control unit includes a memory for storing data on intensities of electric power to be applied to the liquid crystal device depending upon recording layers to or from which data are recorded or reproduced and a selection unit for deciding an intensity of the electric power to be applied from the memory and outputting a control signal based on the decided value.

Preferably, the focus adjustment unit includes at least two focus lenses including a movable lens. The control unit outputs a drive signal for driving the movable lens of the focus adjustment unit to control the light beams to be irradiated to different recording layers. The light receiving unit includes an RF light receiving unit for receiving the reflected light beams separated by the polarized device and a GE light receiving unit for receiving the reflected light beams separated by the non-polarized device. The control unit controls a distance between the second lens and the recording medium according to a gap error signal corresponding to the signal of the GE light receiving unit. Also, the recording/playback apparatus further includes a second control unit for outputting a command to record data to the recording medium or reproduce data from the recording medium to the control unit.

In a further aspect of the present invention, provided herein is a method for recording to and/or reproducing from a multilayered recording medium, including driving a focus adjustment unit to focus light beams on a corresponding recording layer of the multilayered recording medium, applying electric power of an intensity corresponding to the corresponding recording layer to a liquid crystal device to compensate for a spherical aberration, and recording or reproducing data to or from the corresponding recording layer.

Preferably, the step of driving the focus adjustment unit includes moving a focus lens constituting the focus adjustment unit to change incident angles of the light beams incident on a lens unit.

Preferably, the step of applying the electric power to the liquid crystal device includes finding a position of the corresponding recording layer to or from which data are to be recorded or reproduced and an intensity of the electric power corresponding to the position from previously stored data.

Preferably, the method further includes performing a gap servo using a gap error signal. Here, the step of performing the gap servo includes controlling a distance between a lens unit and the recording medium to be uniformly maintained while feedback controlling the gap error signal to have a fixed value.

### ADVANTAGEOUS EFFECTS

As apparent from the above description, the lens unit, the optical system, the recording/playback apparatus and the method for recording to and/or reproducing from the recording medium according to the present invention have the following effects.

The present invention has the effect of compensating for a spherical aberration during the movement of a recording layer.

Also, the present invention has the effect of providing a lens unit usable for a multilayered recording medium and an apparatus using the same.

Also, the present invention has the effect of providing a lens unit usable for a multilayered recording medium in an apparatus using a near field and an apparatus using the same.

Also, the present invention has the effect of providing a focus control method and a method for recording to and/or reproducing from a recording medium using the same.

Furthermore, the present invention has the effect of stably controlling the distance between a lens unit and a recording medium to form a near field.

### BRIEF DESCRIPTION OF THE DRAWINGS

The accompanying drawings, which are included to provide a further understanding of the invention, illustrate embodiments of the invention and together with the description serve to explain the principle of the invention.

In the drawings:

FIG. 1 is a block diagram illustrating the structure of a recording/playback apparatus according to an embodiment of the present invention;

FIG. 2 is a block diagram illustrating an embodiment of an optical system of an optical pickup included in the recording/playback apparatus according to the present invention;

FIG. 3 is a sectional view schematically illustrating an embodiment of a lens unit of the optical pickup according to the present invention with a recoding medium also illustrated;

FIGS. 4A and 4B are side sectional views illustrating an embodiment of a liquid crystal device included in the optical pickup according to the present invention;

FIG. 5 is a view schematically illustrating the change of optical paths by a focus adjustment unit according to an embodiment of the present invention with an object lens also illustrated;

FIGS. 6A to 6C are views schematically illustrating concrete embodiments of the focus adjustment unit according to an embodiment of the present invention;

FIGS. 7A to 7C are views schematically illustrating the change of a focusing position in an embodiment of the focus adjustment unit according to the present invention;

FIG. 8 is a view schematically illustrating the flow of light focused on a first recording layer in the lens unit of FIG. 3;

FIG. 9 is a view schematically illustrating the flow of light focused on a second recording layer in the lens unit of FIG. 3;

FIG. 10 is a graph illustrating the change of a gap error signal (GE) based on the distance between the lens unit and a recording medium; and

FIG. 11 is a flow chart illustrating the sequence of a method for recording to and/or reproducing from a recording medium.

FIG. 12 is a flow chart illustrating a method for controlling the distance between the lens unit and the recording medium to be uniformly maintained using the GE.

FIG. 13 is a view illustrating the GE light receiving unit including four photodetectors PDA, PDB, PDC, and PDD.

### BEST MODE FOR CARRYING OUT THE INVENTION

Reference will now be made in detail to the preferred embodiments of the present invention, examples of which are illustrated in the accompanying drawings. Wherever possible, the same reference numbers will be used throughout the drawings to refer to the same or like parts. In this specification, an example of a recording/playback apparatus using a near field will be described in detail for convenience of description.

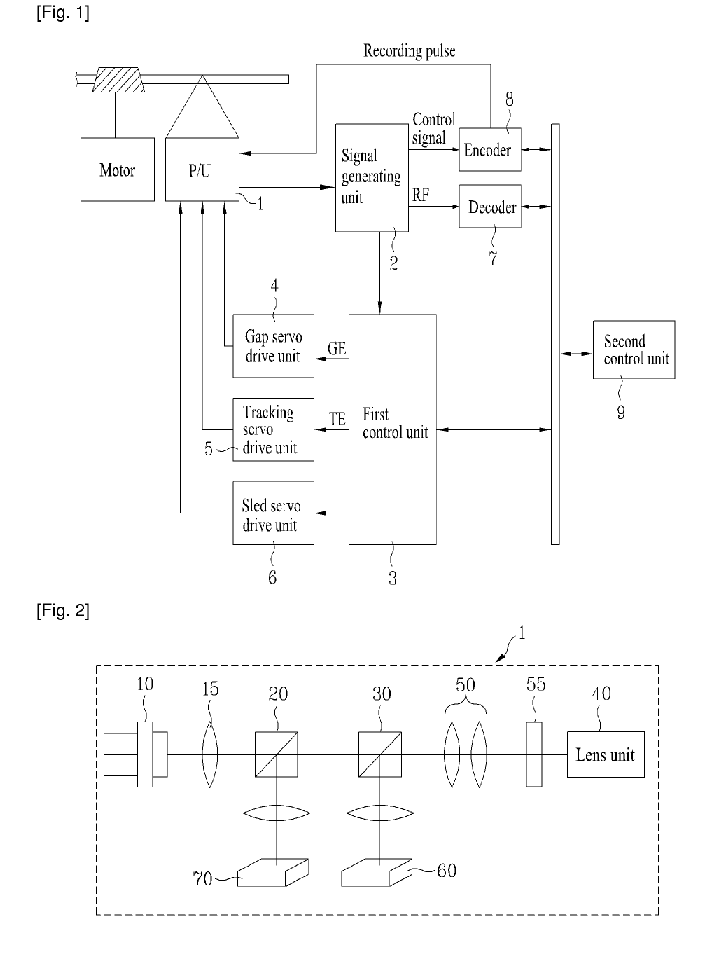

FIG. 1 schematically illustrates the structure of a recording/playback apparatus according to an embodiment of the present invention. The recording/playback apparatus will be described hereinafter in detail with reference to FIG. 1.

The optical pickup (P/U) 1 of FIG. 1 serves to irradiate light to a recording medium and receive light reflected from the recording medium to generate an electric signal corresponding to the reflected light. The structure of the optical pickup 1 will be described in more detail hereinafter.

A signal generating unit 2 generates a recording/playback signal (also referred to as an ‘RF signal’ necessary for data playback, a gap error signal (hereinafter, referred to as a ‘GE’ which will be described in detail hereinafter) for servo control, and a tracking error signal (hereinafter, referred to as a ‘TE’, using the electric signal generated by the optical pickup 1.

A first control unit 3 receives a signal generated by the signal generating unit 2 to generate a control signal or a drive signal. For example, the first control unit 3 processes the GE and outputs a drive signal for controlling the distance between a lens unit 40 and the recording medium to a gap servo drive unit 4. Alternatively, the first control unit 3 processes the TE and outputs a drive signal for tracking control to a tracking servo drive unit 5. Also, the first control unit 3 may output a drive signal for changing the position focused on the recoding medium to the gap servo drive unit 4 or an additional focus drive unit (not shown).

Also, the first control unit 3 decides the intensity of electric power to be applied to a liquid crystal device, which will be described in detail hereinafter, and outputs a control signal corresponding to the decided intensity of the electric power. To this end, the first control unit 3 includes a memory (not shown) that previously stores appropriates intensities of electric power to be applied to the liquid crystal device to compensate for a spherical aberration along a recording layer (for example, a first recording layer or a second recording layer) to or from which data are recorded or reproduced. Also, the first control unit 3 further includes a selection unit for selecting an intensity of electric power to be applied based on the position of the current recording layer among the data stored in the memory (not shown) and outputting a control signal based on the selected value.

Also, the first control unit 3 outputs a drive signal to drive a movable lens of a focus control unit, which will be described hereinafter, such that light can be irradiated on different recording layers.

The gap servo drive unit 4 moves the optical pickup 1 or the lens unit 40 of the optical pickup in an optical axis direction by driving an actuator (not shown) in the optical pickup 1. As a result, it is possible to uniformly maintain the distance between the lens unit 40 and the recording medium. Without the provision of an additional focus drive unit, the gap servo drive unit 4 may drive the actuator in the optical pickup 1, such that a focus adjustment unit 35 can be moved in the optical axis direction. With the provision of an additional focus drive unit, on the other hand, the focus drive unit may move the focus adjustment unit 35 in the optical axis direction according to a drive signal from the first control unit 3.

The tracking servo drive unit 5 moves the optical pickup 1 or the lens unit 40 of the optical pickup in the radial direction, by driving a tracking actuator (not shown) in the optical pickup 1, to correct the position of light. As a result, it is possible for the optical pickup 1 or the lens unit 40 of the optical pickup to follow a predetermined track provided on the recording medium. Also, the tracking servo drive unit 5 may move the optical pickup 1 or the lens unit 40 of the optical pickup in the radial direction according to a track moving command.

A sled servo drive unit 6 moves the optical pickup 1 in the radial direction according to the track moving command by driving a sled motor (not shown) provided to move the optical pickup 1.

A host, such as a personal computer (PC), may be connected to the recording/playback apparatus with the above-stated construction. At this time, a portion of the recording/playback apparatus is referred to as a drive. A recording/playback command is inputted to the host from a second control unit 9 via an interface. Also, the second control unit 9 controls a decoder 7, an encoder 8, and the first control unit 3 according to the recording/playback command of the host. Here, the interface may be generally an advanced technology attached packet interface (ATAPI) 110. The ATAPI 110 is an interface between an optical recording/playback apparatus, such as a CD drive or a DVD drive, and the host, which is proposed to transmit data decoded by the optical recording/playback apparatus to the host. The ATAPI 110 serves to convert and transmit the decoded data into a packet type protocol, which can be processed by the host. As a result, the reproduced data is transmitted from the decoder 7 to the ATAPI 110, and the ATAPI 110 transmits data to be recorded, to perform the recoding or playback of data.

Hereinafter, the structure of a concrete embodiment of an optical system (not shown) included in the optical pickup 1 will be described in detail with reference to the related drawing.

FIG. 2 schematically illustrates a first concrete embodiment of an optical system included in the optical pickup 1. In this embodiment, laser exhibiting a high straight movability may be used as a light source 10. Specifically, therefore, the light source 10 may include, but is not limited to, a laser diode. Also, light to be emitted from the light source 10 and irradiated to the recording medium may be collimated light. To this end, a collimator 15 may be mounted on a path of the light emitted from the light source to collimate the path of the light. That is, the collimator 15 is mounted on the path of light emitted from a point light source to convert the path of the light into collimated light.

Beam splitters 20 and 30 are units for separating the paths of beams incident in the same direction or synthesizing the paths of beams incident in the different directions. In this embodiment, a non-polarized beam splitter (hereinafter, referred to as an ‘NBS’ and a polarized beam splitter (hereinafter, referred to as ‘PBS’ are used as an example. Here, the NBS 20 serves to transmit some light and reflect some light irrespective of the polarization. To this end, the NBS 20 may include a half mirror. On the other hand, the PBS 30 is a polarizer that transmits only polarized light having a specific direction according to the polarizing direction. The use of straightly polarized light will be described as an example. Here, the straightly polarized light may be divided into two straightly polarized light components having a phase difference of 0, ±1, ±2 . . . which vibrate perpendicularly in a plane perpendicular to an optical axis, i.e., the advancing direction of the light. Here, the polarized light component which vibrates in the horizontal direction is referred to as an ‘x-axis polarized light’ for convenience of description. On the other hand, the polarized light component which vibrates in the vertical direction is referred to as a ‘y-axis polarized light’ for convenience of description. The PBS may be configured to transmit only the x-axis polarized light component of the incident light and reflect the y-axis polarized light component of the incident light. Alternatively, the PBS may be configured to transmit only the y-axis polarized light component of the incident light and reflect the x-axis polarized light component of the incident light. In this embodiment, the PBS 30 that transmits only the x-axis polarized light component of the incident light and reflects the y-axis polarized light component of the incident light will be described as an example for convenience of description.

A wavelength plate 55 serves to change the phase of the polarized light. To this birefringence body in which the advancing speed of light changes depending upon the polarized state of the light with the result that birefringence occurs. In the present invention, the use of a quarter wavelength plate (hereinafter, referred to as a ‘QWP’ is illustrated as an example. In the QWP 55, the speed of the incident light transmitted through the corresponding wavelength plate changes to form the difference of a quarter wavelength.

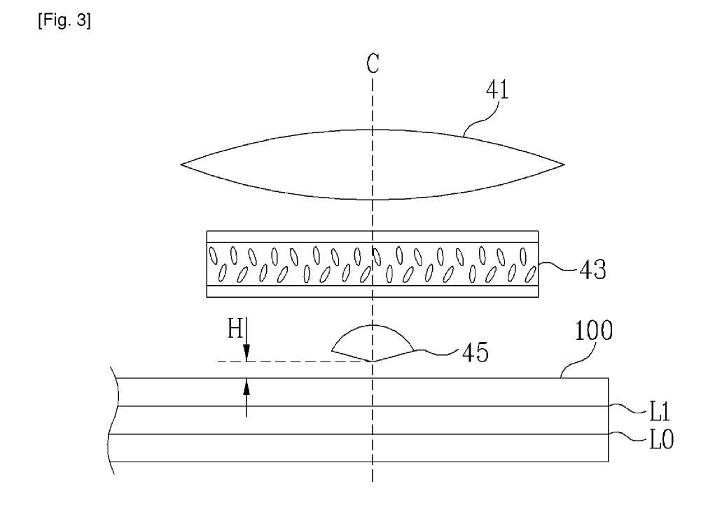

The lens unit 40 serves to irradiate light emitted from the light source 10 to a recording medium and condense the light reflected from the recording medium. In this embodiment, the lens unit 40 forms a near field. An embodiment of the lens unit 40 will be described hereinafter in detail with reference to FIG. 3.

The lens unit 40 includes an object lens and a lens having a high refractive index to increase a numerical aperture and form an evanescent wave, thereby forming a near field. Specifically, as shown in FIG. 3, the lens unit 40 includes an object lens 41 and a high refractive index lens 45 provided on a path along which light transmitted through the object lens 41 is incident on a recording medium 100. In the present invention, the object lens 41 and the high refractive index lens 45 included in the lens unit 40 may be modified in various forms. Hereinafter, the high refractive index lens 45 will be referred to as a ‘near field forming lens’ for convenience of description. The near field forming lens may be modified in various forms. As a concrete example, the near field forming lens may be configured in the form of a cone as shown in the drawing. In this case, the area of the near field forming lens adjacent to the recording medium 100 is minimized, thereby maximally securing a range in which the near field forming lens can tilt. At this time, the cone is provided at the end thereof with a base plane having the minimum area on which the light can be focused. Consequently, it is possible to configure the near field forming lens 45 to be used while the near distance between the near field forming lens 45 and the recording medium 100 is maintained, as will be described hereinafter.

In the recording/playback apparatus using the near field, it is required for the near field forming lens 45 to be very adjacent to the recording medium 100. As shown in FIG. 3, it is required for the distance (indicated by H) between the near field forming lens 45 and the recording medium 100 to be maintained at a nanometer or micrometer level. The relationship between the lens unit 40 and the recording medium 100 will be described in detail as an example.

When the distance between the lens unit 40 and the recording medium 100 is equal to or less than approximately ¼ of the light wavelength (i.e., λ/4), some light incident on the lens unit 40 at an angle of not less than a critical angle is not totally reflected from the surface of the recording medium 100 but forms an evanescent wave, which is transmitted through the recording medium 100 and then reaches a recording layer. The evanescent wave having reached the recording layer may be used for recording and reproduction. As a result, it is possible to store bit information of high density with light equal to or less than a diffraction limit. On the other hand, when the distance between the lens unit 40 and the recording medium 100 is greater than λ/4, the wavelength of the light lose the property of the evanescent wave, and therefore, the light has the original wavelength. As a result, the light is totally reflected from the surface of the recording medium 100 or the surface of the near field forming lens 45. In this case, no evanescent wave is formed, and therefore, the recording and reproduction by the near field are not possible. In the recording/playback apparatus generally using the near field, therefore, the lens unit 40 is controlled such that the distance between the lens unit 40 and the recording medium 100 does not exceed approximately λ/4. Here, the λ/4 is a limit of the near field. That is, it is necessary to maintain the distance between the lens unit 40 and the recording medium 100 at a nanometer level to use the near field. In this embodiment, a method for maintaining the distance between the lens unit 40 and the recording medium 100 at a nanometer level is to use a gap error signal (hereinafter, referred to as a ‘GE’, which will be described in detail hereinafter.

Also, it is required for the object lens 41 to be aligned with the near field forming lens 45. This alignment may be destroyed during the movement of the object lens 41. For this reason, the object lens 41 is configured to be fixed such that the object lens 41 cannot move. For example, the object lens 41 and the near field forming lens 45 may be coupled to each other by a lens barrel to construct a single lens assembly. At this time, the lens unit 40 further includes a liquid crystal device 43 to compensate for a spherical aberration (SA) formed by the lens assembly. The liquid crystal device 43 may be divided into parts having different electric or magnetic properties, which are mounted at the top of the lens assembly to compensate for the spherical aberration formed by the lens assembly. In this embodiment, as shown in FIG. 3, the liquid crystal device 43 is located between the object lens 41 and the near field forming lens 45 as an example.

A liquid crystal (LC) constituting the liquid crystal device 43 is matter having a regular phase in which liquid crystal molecules are regular in positions occupied by the liquid crystal molecules and in the axis directions of the liquid crystal molecules as in a solid and an irregular mesomorphic phase in which liquid crystal molecules are irregular in positions occupied by the liquid crystal molecules and in the axis directions of the liquid crystal molecules as in a general isotropic liquid. The liquid crystal exhibits fluidity and, at the same time, the optical and electric properties of the liquid crystal exhibit anisotropy like a crystal. The liquid crystal device 43 exhibits an orientation of the liquid crystal molecules due to an electric field or a magnetic field, and therefore, it is possible to adjust a refractive index using the orientation of the liquid crystal molecules. That is, the electric field or the magnetic field is formed in the liquid crystal device 43 to obtain the effect of changing the distance between the object lens 41 and the near field forming lens 45.

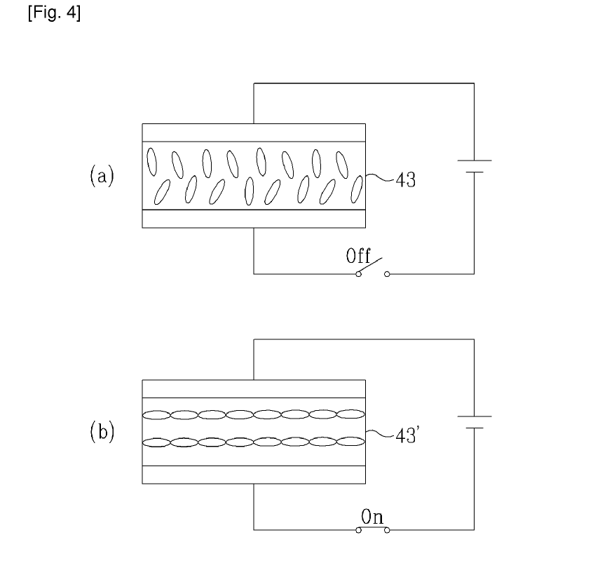

FIGS. 4A and 4B illustrate the application of electric power to the liquid crystal device 43 to form an electric field. When the electric power is not applied, as shown in FIG. 4A, liquid crystal molecules constituting the liquid crystal device 43 are arranged in an irregular mesomorphic phase. On the other hand, when a switch is turned on, and therefore, the electric power is applied, the liquid crystal device 43 exhibits an orientation. At this time, the liquid crystal device 43 exhibits other orientations depending upon the properties of the liquid crystal used. In this embodiment, however, the liquid crystal molecules are arranged in parallel to opposite major surfaces of the substrate, as shown in FIG. 4B, for convenience of description.

The optical system of FIG. 2 includes a focus adjustment unit 50. The focus adjustment unit 50 serves to adjust the incident angle of light incident on the lens unit 40 and thus change the position of the light focused on the recording medium 100. That is, the focus adjustment unit 50 serves to change the light focusing position from a first recording layer to a second recording layer so as to record or reproduce data to or from the recording medium 100 having a plurality of recording layers. As previously described, it is required to maintain the distance between the near field forming lens 45 and the recording medium 100 at a nanometer level, and, it is also required to maintain the distance between the object lens 41 and the near field forming lens 45 at a micrometer level. In order to change the position of the light focused on the recording medium 100 by moving the object lens 41 at the micrometer level, it is required to control even 1/10 to 1/100 of the distance. For this reason, it is very difficult to actually change the focusing position through the movement of the object lens 41 while maintaining the relationship between the object lens 41 and the near field forming lens 45. Therefore, the focus adjustment unit is additionally provided to change the focusing position while the positions of the object lens 41 and the near field forming lens 45 are fixed.

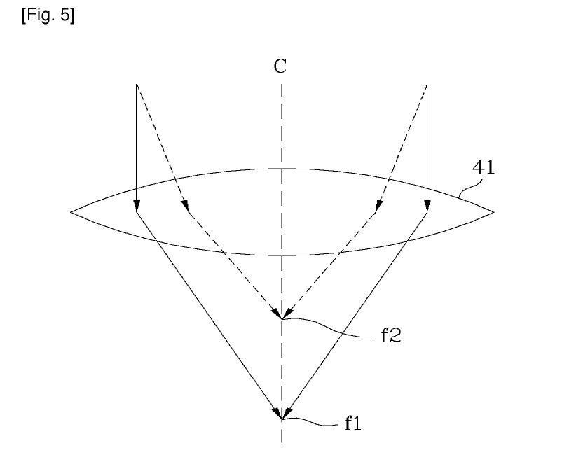

Specifically, an embodiment of the focus adjustment unit 50 will be described in detail hereinafter with reference to FIGS. 5 to 7. As shown in FIG. 5, it is possible to change the focal distance by changing the incident angle of light incident on the object lens 41. Solid lines of FIG. 5 indicate the paths of beams incident on the object lens 41 in parallel to each other. The beams incident in parallel to each other have a focal distance focused on a position f1. On the other hand, dotted lines of FIG. 5 indicate the conversion of incident angles of beams incident on the object lens 41. When beams transmitted through the focus adjustment unit 50 converge to enter the object lens 41 along the paths indicated by the dotted lines, the beams refracted by the object lens 41 have a focal distance focused on a position f2. That is, it is possible to focus the beams on different positions of the recording medium 100 by changing the paths of beams incident on the object lens 41. As a result, it is possible to change the focusing position on the recording medium 100 even in a state in which the object lens 41 is fixed. Therefore, it is necessary to adjust the directions of the beams. For example, it is necessary to maintain the directions of the incident beams or to converge or diverge the incident beams. In this embodiment, the focus adjustment unit 50 performs such a function.

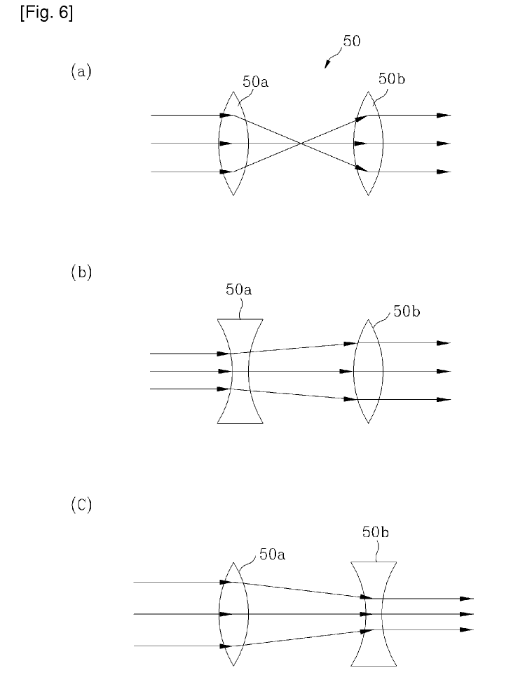

Here, the focus adjustment unit 50 is constructed in a structure to adjust the incident beams such that the advancing paths of the incident beams are maintained or the incident beams are converged or diverged. Concrete embodiments of the focus adjustment unit 50 are shown in FIGS. 6A to 6C. Here, the focus adjustment unit 50 has a structure to adjust the incident beams such that the advancing paths of the incident beams are maintained or the incident beams are converged or diverged. Therefore, the focus adjustment unit 50 may include a combination of at least one convex lens and at least one concave lens.

FIG. 6A illustrates two convex lenses constituting the focus adjustment unit 50. FIGS. 6B and 6C illustrate one convex lens and one concave lens constituting the focus adjustment unit 50. In all the cases, collimated beams are maintained. Here, the focus adjustment unit 50 of FIG. 6B may also serve to increase the diameter of the incident light, and the focus adjustment unit 50 of FIG. 6C may also serve to decrease the diameter of the incident light. In this specification, the focus adjustment unit 50 of FIG. 6A will be described in detail as an example for convenience of description.

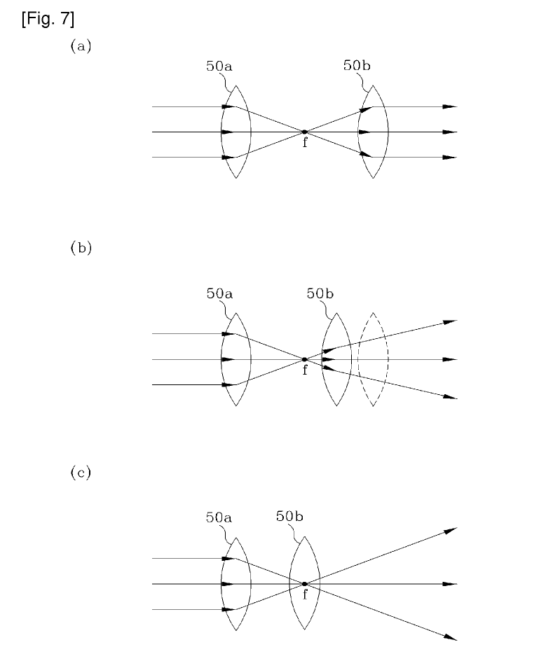

FIGS. 7A to 7C illustrate the change of beam paths by the focus adjustment unit 50 shown in FIG. 6A. FIG. 7A illustrates that a first focus lens 50a and a second focus lens 50b constituting the focus adjustment unit 50 have the same focus. As shown in FIG. 7A, collimated beams, incident on the first focus lens 50a, are incident on the second focus lens 50b through the focus, and therefore, the beams exit as collimated beams. That is, the advancing directions of the incident beams are maintained. At this time, when the focus adjustment unit 50 is configured as shown in FIG. 6B or 6C, the diameter of the collimated light changes.

FIGS. 7B and 7C illustrate that the first focus lens 50a and the second focus lens 50b constituting the focus adjustment unit 50 have different focuses depending upon the movement of the second focus lens 50b. As shown in FIGS. 7B and 7C, collimated beams, incident on the first focus lens 50a, diverge through the second focus lens 50b. In this way, it is possible to form a diverging light or a converging light by configuring the structure of the focus adjustment unit 50 such that any one of the lenses is movable (In this embodiment, the second focus lens 50b is movable). As a result, the direction of light incident on the lens unit 40 is converted, and therefore, the position of the light focused on the recording medium 100 is changed. That is, it is possible to control the light to be focused on different recording layers of the recording medium 100 irrespective of the movement of the object lens 41.

Also, the optical system further includes light receiving units 60 and 70 for receiving the light reflected from the recording medium 100 through the lens unit 50. Here, the light receiving units serve to receive the reflected light and generate an electric signal corresponding to the light intensity of the reflected light through photoelectric conversion. To this end, the light receiving units 60 and 70 may include two photodetectors particularly divided, for example divided into two parts, in the signal track direction or the radial direction of the recording medium 100, or four photo-detectors divided into two parts in the signal track direction and the radial direction of the recording medium 100, respectively. In this embodiment, the optical system including an RF light receiving unit 60 and a GE light receiving unit 70 as shown in FIG. 2 will be described as an example.

The optical system further includes a lens drive unit (not shown) to drive the lens unit 40. The lens drive unit serves to adjust the lens unit 40. The lens drive unit may be configured to minutely drive the lens unit 40 using an electric field or a magnetic field. To this end, an actuator with a wound coil may be used.

Hereinafter, the operation of the optical pickup 1 constituting an embodiment of the recording/playback apparatus will be described in detail based on the advancing direction of light emitted from the light source 10 in the optical system and based on the flow of a signal in other conditions.

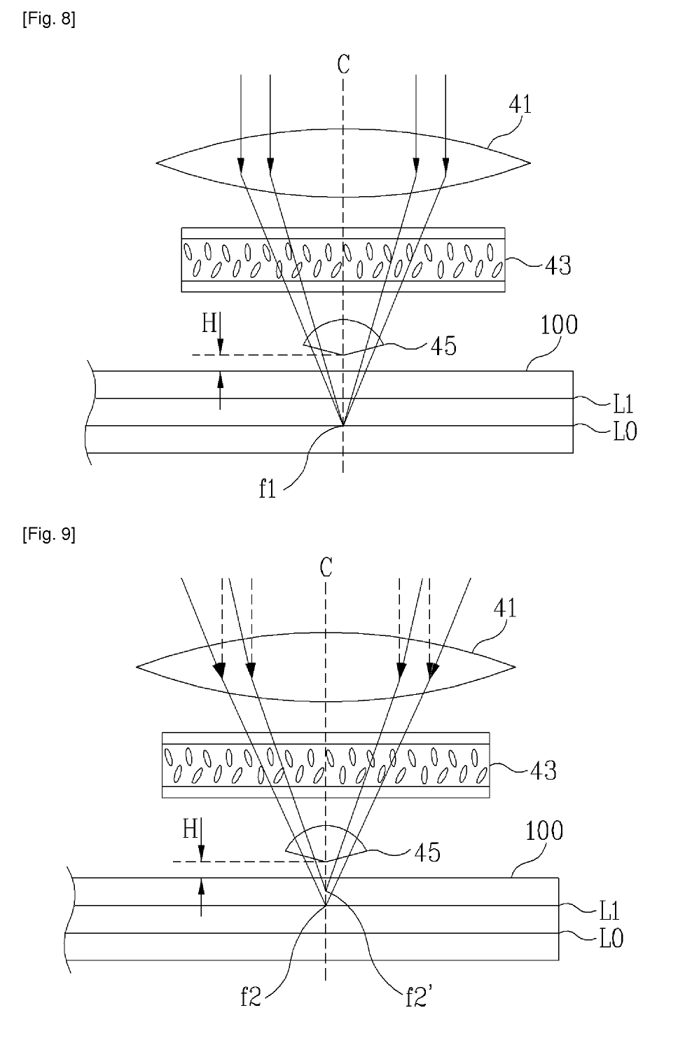

Light emitted from the light source 10 of FIG. 2 is transmitted through the collimator 15, with the result that the light is collimated, and the collimated light is incident on the NBS 20. Some of the light is reflected from the NBS 20, and some of the light is transmitted through the NBS 20. The light transmitted through the NBS 20 is incident on the PBS 30. Polarized light vibrating in the x-axis direction (hereinafter, referred to as an ‘x-axis polarized light’, of the incident light, is transmitted through the PBS 30 and is then incident on the lens unit 40 through the focus adjustment unit 50. Here, the position of light irradiated on the recording medium 100 is adjusted by the focus adjustment unit 50 and the lens unit 40, which will be described in detail with reference to FIGS. 8 to 10.

At the time of manufacturing the optical system, the focus adjustment unit 50 and the lens unit 40 constituting the optical system may be configured to irradiate light to a first recording layer L0 of the recording medium 100. In this case, as shown in FIG. 8, collimated beams, incident on the object lens 40 through the focus adjustment unit 50, may be focused on the first recording layer L0 of the recording medium through the liquid crystal device 43 and the near field forming lens 45 without a spherical aberration.

When it is necessary to record data to a second recording layer L1 of the recording medium 100 or reproduce data from the second recording layer L1 of the recording medium 100, as shown in FIG. 5, the focus adjustment unit 50 is adjusted, i.e., the lens constituting the focus adjustment unit 50 is moved, to change the incident angle of light incident on the object lens 41. In this case, as shown in FIG. 9, the incident angle of the light incident on the object lens 41 is changed, and therefore, the light is irradiated to the second recording layer L1 of the recording medium 100. However, a spherical aberration occurs at the object lens 41 due to the change of the incident angle of the light, with the result that the light is focused on different positions depending upon positions where the light is incident on the object lens 41 in correspondence to the spherical aberration. As shown in FIG. 9, some of the light is focused (f2) on the second recording layer L1, and some of the light having the spherical aberration is focused (for example, f2′) on a position deviating from the second recording layer L1. Consequently, as shown in FIG. 4B, an electric field is generated to change a refractive index formed by the liquid crystal device 43. That is, the optical distance between the object lens 41 and the near field forming lens 45, i.e., an optical path, is decided by a refractive index and a physical path, as represented by Mathematical equation 1 below. In the following equation, L indicates an optical path, n indicates a refractive index, and 1 indicates a physical path.

L=n*l [Mathematical equation 1]

As previously described, electric power is applied to the liquid crystal device 43 to generate an electric field. At this time, it is possible to adjust the orientation of molecules constituting the liquid crystal by adjusting the intensity of the electric field. This is to change a refractive index n of the light transmitting through the liquid crystal device 43, thereby obtaining the effect of changing the optical path. At this time, the intensity of the electric power applied to compensate for the spherical aberration and the intensity of the generated electric field may be experimentally decided and set.

In particular, the light incident on the liquid crystal device 43 through the object lens 41 is not collimated light but condensed light, and therefore, the light is incident on the molecules constituting the liquid crystal in different directions. Consequently, it is not necessary to apply different voltages through the articulation. That is, when a predetermined electric power is applied to a liquid crystal device 43 such that the liquid crystal device 43 exhibits an orientation, the refractive index changes depending upon the direction in which the light is incident. Consequently, it is possible to compensate for the spherical aberration and control the light to be completely condensed on the second recording layer L1.

The light irradiated to the recording medium 100 by the lens unit 40 and then reflected from the respective recording layers is condensed again through the lens unit 40. The condensed light is converted into polarized light vibrating in the y-axis direction (hereinafter, referred to as a ‘y-axis polarized light’ by the wavelength plate 55. Here, the wavelength plate 55 right-circular polarizes the light directed to the lens unit 40 and left-circular polarizes the light reflected and condensed by the lens unit 40 such that the reflected light has a polarization direction in which the reflected light deviates from the incident light by 90 degrees.

The light transmitted through the focus adjustment unit is incident on the PBS 30, and, since the light is y-axis polarized light, the light is reflected and received by the RF light receiving unit 60. Some of the light distorted by the lens unit 40 having a high numerical aperture is transmitted through the PBS 30, and is then incident on the NBS 20. Some of the light is incident on the GE light receiving unit 70 by the NBS 20.

Here, the light incident on the RF light receiving unit 60 may be used to generate a recording/playback signal (RF signal) or a tracking error signal (TE). Also, the light incident on the GE light receiving unit 70 may be used to generate a gap error signal (GE). In this specification, a structure in which the GE light receiving unit 70 includes two photo-detectors PDA and PDB in the embodiment of FIG. 2 will be described as an example for convenience of description. The two photo-detectors output electric signals a and b corresponding to the intensity of the received light. The signal generating unit 2 of FIG. 2 generates a gap error signal (GE) using the electric signal outputted from the GE light receiving unit 70. The gap error signal (GE) may be generated by adding signals outputted from the photo-detectors constituting the GE light receiving unit 70. The gap error signal (GE) thus generated may be represented by the following equation.

GE=a+b [Mathematical equation 2]

Here, the gap error signal (GE) corresponds to the total sum of the electric signals corresponding to the light intensity. Consequently, the gap error signal (GE) is proportional to the intensity of the reflected light received by the GE light receiving unit 70.

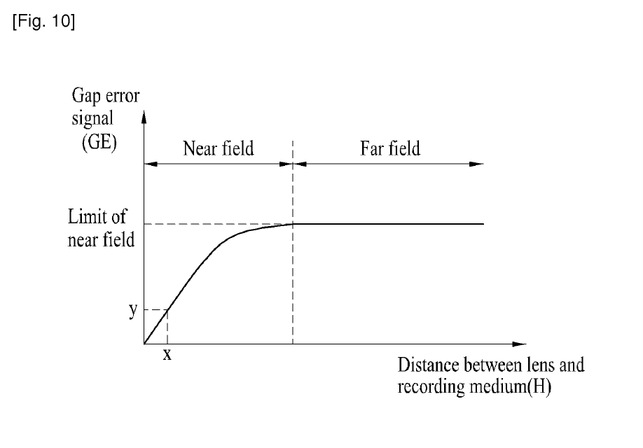

As shown in FIG. 10, the gap error signal (GE) increases exponentially with the increase of distance H between the lens unit 40 and the recording medium 100 in the near field, and the gap error signal (GE) has a fixed value out of the near field, i.e., in the far field. More specifically, when the distance H between the lens unit 40 and the recording medium 100 deviates from the near field, i.e., the distance H between the lens unit 40 and the recording medium 100 is equal to or greater than the limit of the near field (in other words, the boundary between the near field and the far field), λ/4, light incident at an angle of not less than a critical angle is totally reflected from the surface of the recording medium 100. On the other hand, when the distance H between the lens unit 40 and the recording medium 100 is less than λ/4, with the result that the near field is generated, some of the light incident at the angle of not less than the critical angle is transmitted through the recording medium 100 and reaches a corresponding recording layer, although the lens unit 40 and the recording medium 100 are not brought into contact with each other. Consequently, the less the distance H between the lens unit 40 and the recording medium 100 is, the more the intensity of the light transmitted through the recording medium 100 is, whereas the less the intensity of the light totally reflected from the surface of the recording medium 100 is. Also, the greater the distance H between the lens unit 40 and the recording medium 100 is, the less the intensity of the light transmitted through the recording medium 100 is, whereas the more the intensity of the light totally reflected from the surface of the recording medium 100 is. As a result, the relationship as shown in FIG. 4 is established. Consequently, the intensity of the gap error signal (GE), proportional to the intensity of the reflected light, increases exponentially with the increase of distance H between the lens unit 40 and the recording medium 100 in the near field, as shown in FIG. 4, and the gap error signal (GE) has a fixed value (maximum value) out of the near field. Based on this principle, the gap error signal (GE) has a fixed value when the distance H between the lens unit 40 and the recording medium 100 is uniformly maintained in the near field. That is, feedback control is carried out, such that the gap error signal (GE) has such a fixed value, to control the distance H between the lens unit 40 and the recording medium 100 to be uniformly maintained.

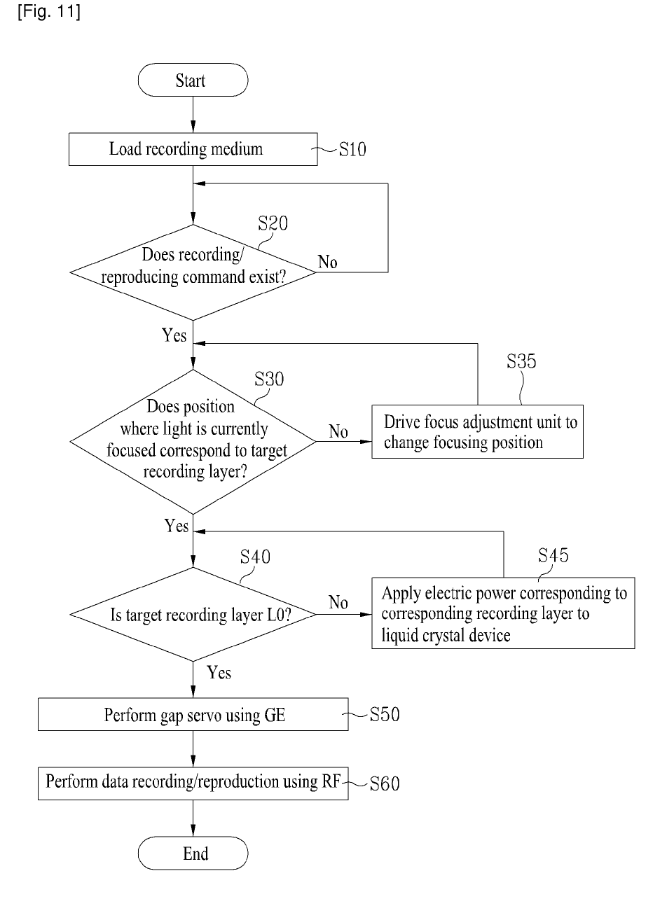

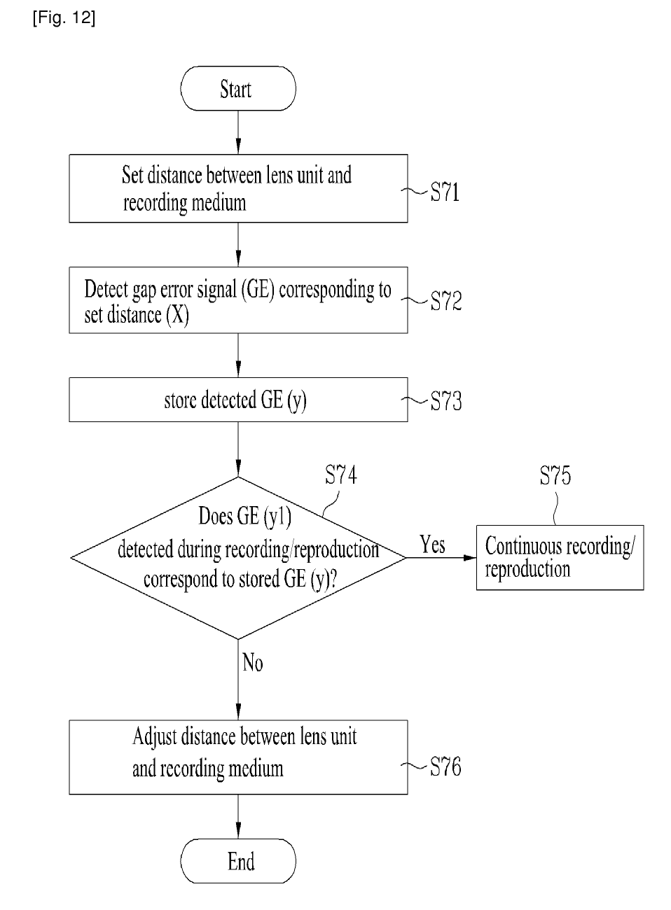

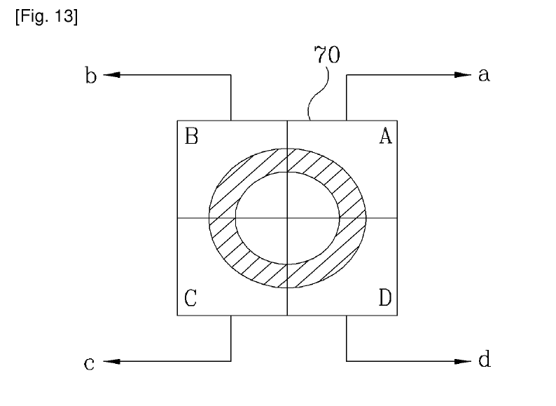

Hereinafter, a data recording and/or reproducing method according to an embodiment of the present invention will be described in detail with reference to FIGS. 11 and 12.

When a recording medium is loaded into the recording/playback apparatus (S10), the recording medium is maintained in a standby mode. At this time, it is determined whether a recording or reproducing command inputted from the outside or programmed for automatic execution exists (S20). When it is determined that the recording or reproducing command exists, light is outputted from the light source. The outputted light is focused on a recording layer of the recording medium. At this time, it is determined whether the position where the light is currently focused corresponds to a target recording layer to or from which data is to be recorded or reproduced (S30). For example, when the optical system is configured based on the first recording layer L1 at the time of manufacturing the optical system, the initially focused position may be set to be the first recording layer L0. Consequently, when the target recording layer is the first recording layer L0, a corresponding track will be found from the focused recording layer, and, when the target recording layer is another recording layer (for example, the second recording layer L1), the focus adjustment unit is driven to change the focusing position (S35). When the focus adjustment unit is driven once or repeatedly several times to change the focusing position such that the focusing is performed on the target recording layer, it is required to compensate for the spherical aberration. For example, when the optical system is manufactured based on the first recording layer L0, as previously described, the first recording layer L0 has no spherical aberration. Consequently, as shown in FIG. 11, it is determined whether the target recording layer is the first recording layer L0 (S40). When it is determined that the target recording layer is not the first recording layer L0, the previously stored electric power is applied to the liquid crystal device depending upon the position of the corresponding target recording layer (S45). That is, the intensity of electric power necessary to compensate for the spherical aberration corresponding to the position of the recording layer is experimentally decided and stored, and the corresponding electric power is applied, using the data, to compensate for the spherical aberration. Subsequently, a gap servo is carried out using a detected gap error signal (GE) (S50), which will be described in detail with reference to FIG. 12. When the gap servo is stabilized, a process for recording or reproducing data using a detected recording/playback signal (RF) is carried out (S60).

Here, the drive operation of the lens drive unit by the gap error signal (GE) may be configured to be continuously feedback controlled during the recording or reproduction of data. A method for controlling the distance between the lens unit 40 and the recording medium 100 to be uniformly maintained using the gap error signal (GE) as previously described will be described in detail with reference to FIG. 12.

The distance x between the lens unit and the recording medium suitable for the detection of a reflected light signal is set (S71). A gap error signal (GE) y corresponding to the set distance x is detected (S72). The detected gap error signal (GE) y is stored (S73). Here, y may be set to be greater than 10 to 20% of the limit of the near field (λ/4) to avoid a possibility that the lens unit and the recording medium collide with each other. Also, y may be set to be less than 80 to 90% of the limit of the near field (λ/4) to avoid a possibility that the distance between the lens unit and the recording medium increases to deviate from the near field. The above-described process may be carried out before recording/reproducing data to/from the recording medium.

While the data are recorded to or reproduced from the recording medium, which is rotating, the light the polarizing direction of which is distorted, of the light irradiated to a track of the recording medium, is reflected and received by the GE light receiving unit. And the signal generating unit generates a gap error signal (GE) using a signal outputted from the GE light receiving unit. At this time, it is determined whether the detected gap error signal (GE) y1 corresponds to the stored gap error signal (GE) y (S74). When it is determined that the detected gap error signal (GE) y1 corresponds to the stored gap error signal (GE) y, which means that the set distance is maintained, the recording/reproducing process is continuously carried out (S75). On the other hand, when it is determined that the detected gap error signal (GE) y1 does not correspond to the stored gap error signal (GE) y, which means that the distance between the lens unit and the recording medium has changed, the lens unit is driven to adjust the distance between the lens unit and the recording medium (S76). In this way, the lens unit is feedback controlled, using the gap error signal (GE) detected at the recording/reproducing process, thereby uniformly maintaining the distance between the lens unit and the recording medium.

Hereinafter, a recording/playback apparatus including an optical system according to another embodiment of the present invention and a method for recording to and/or reproducing from a recording medium will be described in detail with reference to the drawings. For convenience of description, components of this embodiment identical to those of the previous embodiment will not be described, and only components of this embodiment different from those of the previous embodiment will be described.

In the optical system according to this embodiment, the liquid crystal device shown in FIG. 4 is located at the position of the wavelength plate 55 shown in FIG. 2. The lens unit 40 may be configured as shown in FIG. 3. Alternatively, the lens unit 40 may be configured to include only the object lens 41 and the near field forming lens 45 excluding the liquid crystal device 43. Other constructions are identical to those described with reference to FIG. 2.

The light the polarizing direction of which is changed by the high refractive index lens, of the light totally reflected from the surface of the near field forming lens 45 of the optical system, is incident on the GE light receiving unit 70 as previously described. A gap error signal (GE) is generated using the light incident on the GE light receiving unit 70. In this embodiment, the GE light receiving unit 70 including four photo-detectors PDA, PDB, PDC, and PDD as shown in FIG. 13 will be described as an example for convenience of description. The four photo-detectors output electric signals a, b, c, and d corresponding to the intensity of the received light. The signal generating unit 2 of FIG. 2 generates a gap error signal (GE) using the electric signal outputted from the GE light receiving unit 70. The gap error signal (GE) may be generated by adding signals outputted from the photo-detectors constituting the GE light receiving unit 70. The gap error signal (GE) thus generated may be represented by the following equation.

GE=a+b+c+d [Mathematical equation 3]

Here, some of the light adjacent to the optical axis and thus having a small incident angle, of the light incident on the near field forming lens 45, is not totally reflected from the surface of the near field forming lens 45 but reaches the recording medium 100 and then reflected from the recording medium 100. Some of the light reflected from the recording medium 100 is converted into light the polarizing direction of which is distorted due to a birefringence phenomenon according to the properties of the recording medium 100. The distorted light is also incident on the GE light receiving unit 70. As a result, an error may be included in the gap error signal (GE), and therefore, it is necessary to remove the error.

To this end, the liquid crystal device is disposed at the position of the wavelength plate 55, and electric power is applied to the liquid crystal device to adjust the polarizing direction of the light transmitted through the liquid crystal device. At this time, an error signal represented by Mathematical equation 4 below is formed to control the error signal included in the gap error signal, and the electric power is applied to the liquid crystal device, such that the error signal is minimized, to adjust the polarizing direction of the light.

Error=k[(a+b)−(c+d)] [Mathematical equation 4]

That is, when a recording medium 100 having no birefringence is loaded, as shown in FIG. 13, symmetrical light is received. At this time, basic voltage is applied to the liquid crystal device to serve as the wavelength plate 55 as described in the previous embodiment. On the other hand, when a recording medium 100 having birefringence is loaded, as shown in FIG. 13, light of which the symmetry is destroyed due to an error is received by the GE light receiving unit 70. Consequently, the voltage applied to the liquid crystal device is changed to perform polarizing adjustment with respect to the corresponding recording medium 100 such that the birefringence according to the polarizing direction does not occur. That is, the applied voltage is adjusted such that the error signal is minimized. Also, while the error signal is being minimized, the gap error signal (GE) is generated, as previously described. Consequently, it is possible to obtain the gap error signal (GE) which is stabilized through the removal of the error.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

### INDUSTRIAL APPLICABILITY

The present invention has the effect of compensating for a spherical aberration during the movement of a recording layer.

Also, the present invention has the effect of providing a lens unit usable for a multilayered recording medium and an apparatus using the same.

Also, the present invention has the effect of providing a lens unit usable for a multilayered recording medium in an apparatus using a near field and an apparatus using the same.

Also, the present invention has the effect of providing a focus control method and a method for recording to and/or reproducing from a recording medium using the same.

Furthermore, the present invention has the effect of stably controlling the distance between a lens unit and a recording medium to form a near field.

1. A lens unit comprising:
a first lens for condensing light beams outputted from a light source to a recording medium;
a second lens for increasing a numerical aperture of the first lens to form a near field; and
a liquid crystal device for compensating for a spherical aberration included in the first lens and the second lens.

2. The lens unit according to claim 1, wherein the liquid crystal device is disposed between the first lens and the second lens, and particles constituting the liquid crystal device exhibit an orientation changeable according to voltage applied to the liquid crystal device.

3. The lens unit according to claim 2, wherein the liquid crystal device exhibits different refractive indexes with respect to light beams incident on the liquid crystal device at different incident angles.

4. An optical system comprising:
a first lens for condensing light beams outputted from a light source to a recording medium;
a second lens for increasing a numerical aperture of the first lens to form a near field;
a liquid crystal device for compensating for a spherical aberration included in the first lens and the second lens;
a focus adjustment unit for changing incident angles of the light beams incident on the first lens;
a beam splitter for separating or synthesizing paths of the light beams; and
a light receiving unit for receiving light beams reflected from the recording medium and condensed through a lens unit constituted by the first lens, the second lens, and the liquid crystal device to generate an electric signal.

5. The optical system according to claim 4, wherein the liquid crystal device is disposed between the first lens and the second lens, and particles constituting the liquid crystal device exhibit an orientation changeable according to voltage applied to the liquid crystal device.

6. The optical system according to claim 5, wherein the liquid crystal device exhibits different refractive indexes with respect to light beams incident on the liquid crystal device at different incident angles.

7. The optical system according to claim 4, wherein the focus adjustment unit comprises at least two focus lenses including a movable lens.

8. The optical system according to claim 7, wherein the beam splitter comprises:
a non-polarized device for transmitting some of the light beams and reflecting some of the light beams; and
a polarized device for transmitting the light beams polarized in a predetermined direction according to a polarizing direction.

9. The optical system according to claim 8, wherein the light receiving unit comprises:
an RF light receiving unit for receiving the reflected light beams separated by the polarized device; and
a GE light receiving unit for receiving the reflected light beams separated by the non-polarized device.

10. A recording/playback apparatus comprising:
a first lens for condensing light beams outputted from a light source to a recording medium;
a second lens for increasing a numerical aperture of the first lens to form a near field;
a liquid crystal device for compensating for a spherical aberration included in the first lens and the second lens;
a focus adjustment unit for changing incident angles of the light beams incident on the first lens;
a beam splitter for separating or synthesizing paths of the light beams;
a light receiving unit for receiving light beams reflected from the recording medium and condensed through a lens unit constituted by the first lens, the second lens, and the liquid crystal device to generate an electric signal; and
a control unit for outputting a control signal corresponding to the electric signal of the light receiving unit.

11. The recording/playback apparatus according to claim 10, wherein the liquid crystal device is disposed between the first lens and the second lens, and particles constituting the liquid crystal device exhibit an orientation changeable according to voltage applied to the liquid crystal device.

12. The recording/playback apparatus according to claim 11, wherein the liquid crystal device exhibits different refractive indexes with respect to light beams incident on the liquid crystal device at different incident angles.

13. The recording/playback apparatus according to claim 11, wherein the control unit comprises:
a memory for storing data on intensities of electric power to be applied to the liquid crystal device depending upon recording layers to or from which data are recorded or reproduced; and
a selection unit for deciding an intensity of the electric power to be applied from the memory and outputting a control signal based on the decided value.

14. The recording/playback apparatus according to claim 10, wherein the focus adjustment unit comprises at least two focus lenses including a movable lens.

15. The recording/playback apparatus according to claim 14, wherein the control unit outputs a drive signal for driving the movable lens of the focus adjustment unit to control the light beams to be irradiated to different recording layers.

16. The recording/playback apparatus according to claim 11, wherein the beam splitter comprises:
a non-polarized device for transmitting some of the light beams and reflecting some of the light beams; and
a polarized device for transmitting the light beams polarized in a predetermined direction according to a polarizing direction.

17. The recording/playback apparatus according to claim 16, wherein the light receiving unit comprises:
an RF light receiving unit for receiving the reflected light beams separated by the polarized device; and
a GE light receiving unit for receiving the reflected light beams separated by the non-polarized device.

18. The recording/playback apparatus according to claim 17, wherein the control unit controls a distance between the second lens and the recording medium according to a gap error signal corresponding to the signal of the GE light receiving unit.

19. The recording/playback apparatus according to claim 11, further comprising:
a second control unit for outputting a command to record data to the recording medium or reproduce data from the recording medium to the control unit.

20. A method for recording to and/or reproducing from a multilayered recording medium, comprising:
driving a focus adjustment unit to focus light beams on a corresponding recording layer of the multilayered recording medium;
applying electric power of an intensity corresponding to the corresponding recording layer to a liquid crystal device to compensate for a spherical aberration; and
recording or reproducing data to or from the corresponding recording layer.

21. The method according to claim 20, wherein the step of driving the focus adjustment unit includes moving a focus lens constituting the focus adjustment unit to change incident angles of the light beams incident on a lens unit.

22. The method according to claim 20, wherein the step of applying the electric power to the liquid crystal device includes finding a position of the corresponding recording layer to or from which data are to be recorded or reproduced and an intensity of the electric power corresponding to the position from previously stored data.

23. The method according to claim 20, further comprising:
performing a gap servo using a gap error signal.

24. The method according to claim 23, wherein the step of performing the gap servo includes controlling a distance between a lens unit and the recording medium to be uniformly maintained while feedback controlling the gap error signal to have a fixed value.
